(19) United States
(12) Patent Application Publication
(10) Pub. No.: US 2009/0141336 A1
(43) Pub. Date: Jun. 4, 2009

(54) PROJECTION DISPLAY DEVICES EMPLOYING FRUSTRATED TOTAL INTERNAL REFLECTION

(75) Inventor: Christopher L. Bohler, North Royalton, OH (US)

Correspondence Address: Fay Sharpe LLP, 1228 Euclid Avenue, 5th Floor, The Halle Building, Cleveland, OH, 44115, US

(73) Assignee: Lumination LLC

(21) Appl. No.: 11/948,233

(22) Filed: Nov. 30, 2007

(51) Int. Cl. G02B 26/00; G02B 26/02

(52) U.S. Cl. 359/292

(57) ABSTRACT

An image forming device for use in an optical projection device includes an optical interface and an array of movable elements selectively movable toward or away from the optical interface to selectively locally frustrate total internal reflection at the optical interface such that light totally internally reflected at the optical interface defines an image. A projection display device includes an optical projector system including the image forming device.

### BACKGROUND

The following relates to the optical arts. It finds particular application in projection display devices, and will find more specific application in conjunction with illustrative projection devices such as televisions, computer displays, overhead projector displays, theatre projectors, and so forth.

Existing television products employ cathode ray tube (CRT) units, liquid crystal display (LCD) units, or plasma display units. CRT-based displays are rapidly losing favor as the display modality of choice due to factors such as high weight, bulkiness, and fragility of the CRT units. LCD and plasma technologies are presently the dominant technology, especially for high definition television (HDTV).

A more recently developed display technology is Digital Light Processing (DLP) technology, which is based on the digital micromirror device (DMD) developed by Texas Instruments, Inc. A DMD device is a microelectromechanical system (MEMS) including an array of micromirrors that are adjustable between two discrete angular positions by suitable MEMS actuators. Each micromirror corresponds to a pixel of the display. One of the discrete angular positions of the micromirror corresponds to the pixel being “on” such that it reflects light into the optical projection system to illuminate the corresponding pixel of the projector display. The other of the discrete angular positions of the micromirror corresponds to the pixel being “off” such that it reflects light elsewhere—usually to an optical sink that is also thermally heatsinking to dissipate heat from the unprojected portion of the light. DLP technology is in use in commercial HDTV products, theatre projectors, and so forth.

DLP technology is touted by its proponents as providing more colors, larger screen sizes, and faster raster updates compared with competing technologies such as LCD and plasma displays. The projection-based DLP technology is readily scalable to large screen sizes using high quality projection optics. Raster updates are fast in part because the updates occur on a small-sized MEMS chip rather than across an entire large-area display as in non-projection-based LCD and plasma technologies. Grayscale levels are provided by fast binary switching of the micromirror between the “on” and “off” states, with the grayscale level being controlled by the duty cycle of the “on” state. Existing DLP displays can readily provide 1024 shades of gray, which in a color display translates into millions of attainable colors.

In spite of these advantages, DLP technology has disadvantages, some of which are a consequence of the complexity of the underlying DMD device. Texas Instruments initially developed the DMD device in 1987. Even driven by the powerful motivator of the lucrative consumer electronics market, it took about a decade of further research and development before DLP projection displays became commercially available at the consumer level. Projection television development has continued to focus on the DLP technology to the present time, and DLP projection televisions are now available from most major brand television manufacturers.

One complexity of the DMD device is the precision with which the angular position of the movable micromirror must be set. The angle of the “on” position of each micromirror must be precisely controlled to ensure that each micromirror properly illuminates its corresponding pixel in the projected display. Because the micromirrors operate independently, such precise angular positional control must be maintained across the entire two-dimensional array of micromirrors. To accomplish this, in some DMD devices each micromirror is configured to come into contact with a landing in the “on” and “off” positions. However, this can lead to a failure mode known as “sticking” in which an individual micromirror adheres or coheres to the landing surface of the MEMS device such that it no longer switches properly.

### BRIEF SUMMARY

In accordance with certain illustrative embodiments shown and described as examples herein, a projection display device is disclosed, comprising: an optical interface; a microelectromechanical system including an array of movable elements corresponding to image pixels, each movable element being movable toward the optical interface to locally frustrate total internal reflection at the optical interface and movable away from the optical interface to not locally frustrate total internal reflection at the optical interface; a light source arranged to illuminate the optical interface at an angle effective for producing total internal reflection at the optical interface; and an optical projector system arranged to project one but not both of (i) light from the light source that undergoes total internal reflection at the optical interface, and (ii) light from the light source that is frustrated by the movable elements from undergoing total internal reflection at the optical interface.

In accordance with certain illustrative embodiments shown and described as examples herein, an image formation device is disclosed, comprising: an optical interface; and a microelectromechanical system including an array of movable elements corresponding to image pixels, each movable element being movable toward the optical interface to locally frustrate total internal reflection at the optical interface and movable away from the optical interface to not locally frustrate total internal reflection at the optical interface.

In accordance with certain illustrative embodiments shown and described as examples herein, an apparatus is disclosed, comprising: an optical interface arranged to reflect a beam of light by total internal reflection; and a microelectromechanical system configured to spatially modulate the total internal reflection across the optical interface such that the beam reflected by total internal reflection defines an image. In some embodiments of the apparatus, an optical projector system is arranged to project the reflected beam to form a projected image.

In accordance with certain illustrative embodiments shown and described as examples herein, a projection display device is disclosed, comprising: an image forming device including an optical interface and an array of movable elements selectively movable toward or away from the optical interface to selectively locally frustrate total internal reflection at the optical interface such that light totally internally reflected at the optical interface defines an image; and an optical projector system including the image forming device.

Numerous advantages and benefits of the present invention will become apparent to those of ordinary skill in the art upon reading and understanding the present specification.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIG. 1 diagrammatically shows a projection display device using a single image formation device employing frustrated total internal reflection.

FIG. 2 diagrammatically shows a schematic cross-sectional view of a portion of one suitable embodiment of the image formation device of FIG. 1.

FIG. 3 diagrammatically shows a schematic cross-sectional view of a portion of another suitable embodiment of the image formation device of FIG. 1.

FIG. 4 diagrammatically shows a projection display device using three image formation devices each employing frustrated total internal reflection.

### DETAILED DESCRIPTION OF PREFERRED EMBODIMENTS

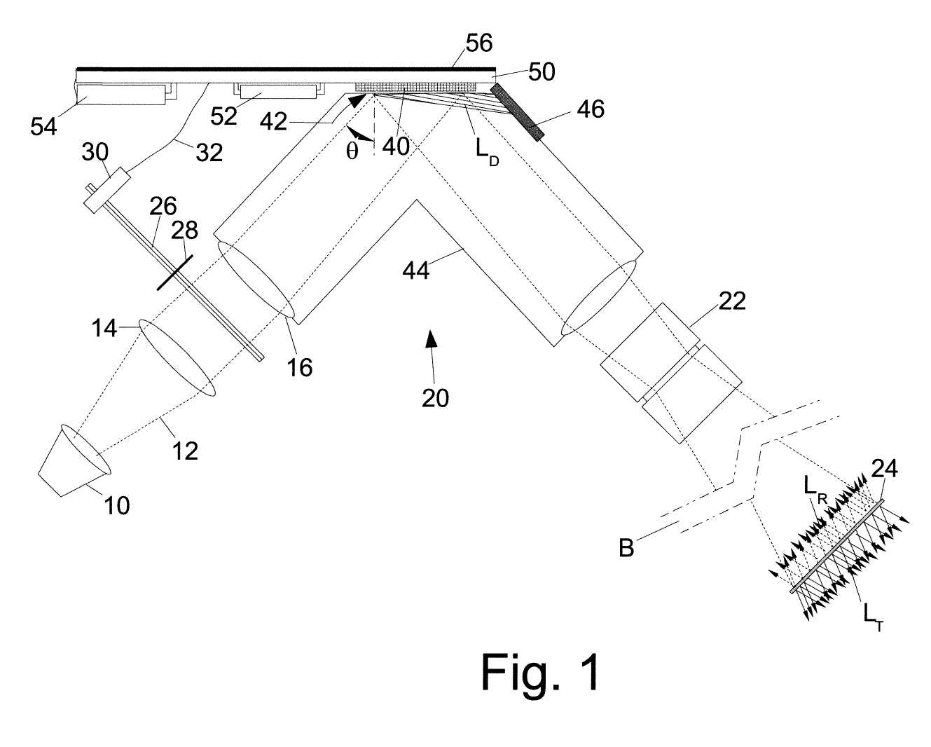

With reference to FIG. 1, a projection display device includes a light source 10 emitting illumination light 12. The light source 10 is in some embodiments a projection lamp such as that used in projection televisions, or such as that used in theatre projectors, or so forth. The light source 10 is typically a white light source. As is known in the art, white light can be considered to be a blending or mixture of three primary colors, such as a blending or mixture of red, green, and blue light.

Optics 14, 16 are arranged to collect the illumination 12 and focus or image it onto an image formation device 20. In the illustrative embodiment of FIG. 1, a collector lens 14 collects the illumination 12 and forms it into a beam, which may be a converging beam, a diverging beam, or a substantially collimated beam. A second lens 16 focuses or images the illumination onto an image formation device 20 to be described herein. It is to be appreciated that substantially any collecting and focusing or imaging optics can be used in place of the illustrative lens combination 14, 16. For example, the light source 10 may shine into a parabolic reflector or other collimating, focusing, or imaging reflector. A single lens can be used in place of the illustrated tandem of lenses 14, 16, or more than two lenses can be used in the optical train.

The image formation device 20 modulates the beam spatially to define an image carried by the modulated illumination. The modulated illumination is received by a projection system 22 that projects the modulated beam onto a screen 24. The projection distance can be substantial for large area projection displays; accordingly, a break B in the projection of the illumination is diagrammatically shown in FIG. 1 to emphasize this. (The diagrammatic break B is included for clarity—however, it is to be appreciated that all drawings herein, including FIGS. 1-4, are diagrammatic in nature and are not drawn to scale).

The projection system 22 can employ any configuration of optics, such as a plurality of cooperating lenses, parabolic reflectors, or so forth, that project the image defined in the modulated illumination onto the screen 24. For example, if the projection display device is a rear projection television, then the projection system 22 is suitably a rear projector, for example of the type known for use in existing DLP projection televisions, and the screen 24 is suitably a light transmissive diffusing screen, for example of the type known for use in existing DLP rear projection televisions. In this arrangement, light L_{T} transmitted through the screen 24 is viewed by a viewer looking at the light transmissive screen from the side opposite the illumination. In other embodiments, the projection display device may be a theatre projector, in which case the projection system 22 is suitably a ceiling-mounted projection system or the like of the type used in theatres, while the screen 24 is suitably a reflective cinematic screen again of the type used in theatres, and reflected light L_{R} is viewed by a viewer looking at the same side as the illumination.

To enable full color display, an optional color filter wheel 26 is included. The color filter wheel 26 rotates about an axis 28 and includes red, green, and blue filters so that the white light produced by the light source 10 is cycled between red, green, and blue colors (or some other ordering of primary colors). Optionally, the color wheel can include a white region as well to provide a high-quality white light for a white cycle portion. An optical sensor 30 tracks angular position of the rotating color filter wheel 26, for example by detecting passage of an opening across the optical sensor 30, which opening is located at a predetermined angular position on the rotating color filter wheel 26. The optical sensor 30 provides a tracking signal for tracking the cyclic red, green, blue, and optional white illumination. A wired connection 32, or alternatively a wireless connection (not shown) communicates the tracking signal to the image formation device 20 which cyclically forms red, green, blue, and optional white images in coordination with the red, green, blue, and optional white illumination cycling. The red, green, blue, and optional white images are cyclically projected onto the screen 24 at a rate related to the rotation rate of the rotating color filter wheel 26, and the cycling rate is selected to be fast enough for the typical human viewer to see the red, green, blue, and optional white images blended together to form a full color image. For example, the repetition rate for the red/green/blue cycle is preferably at least about 15 Hertz, and more preferably at least about 24-30 Hertz. In some embodiments, the projection rate is greater than 100 Hertz. Substantially faster repetition rates are contemplated so as to provide higher screen refresh rates for applications such as high definition television, video gaming, computer displays, and so forth. Moreover, while the color filter wheel 26 is illustrated as a suitable approach usable in conjunction with a white light source for generating cycling of primary colors and optional white, other approaches are contemplated. For example, the light source 10 can be a light emitting diode (LED) based light source having red, green, blue, and optionally white LED devices that are operated cyclically to generate red, green, blue, and optionally white illumination directly without relying upon color filtering of white light. Other approaches for generating temporal cycling of primary colors synchronized with the image formation device 26 are also contemplated. As used herein, “primary colors” is intended to include white so as to encompass either cycling of red, green, and blue illumination or cycling of red, green, blue, and white illumination.

The skilled artisan will appreciate that the arrangement of components 10, 14, 16, 22, 24, 26, 28, 30, 32 shown in FIG. 1 is conventional, and is used as shown or with various modifications in DLP television sets, in theatre projectors, in overhead projectors, and so forth. For example, the arrangement of components 10, 14, 16, 22, 24, 26, 28, 30, 32 may be used substantially as shown in FIG. 1, or with selected modifications, in conjunction with an image formation device in the form of a digital micromirror device (DMD) so as to construct a DLP projection display device. However, the DMD introduces substantial undesirable complexity into the projection display device, and this complexity can translate into higher manufacturing costs, reduced robustness or reliability, and other disadvantages.

Accordingly, the projection display device of FIG. 1 employs the image formation device 20, which is different in kind from the DMD used in DLP projection display devices. The image formation device 20 includes a microelectromechanical system 40 operatively coupled with an optical interface 42 which in the embodiment of FIG. 1 is defined by a bent tube optical element 44 made of a light transmissive material. The illumination light 12 enters one end of the bent tube optical element 44 and reflects off of the optical interface 42 by a total internal reflection (TIR) mechanism to exit the other end of the bent tube optical element 44. As will be described, the microelectromechanical system 40 spatially modulates the TIR by an approach known as frustrated total internal reflection (FTIR) such that the totally internally reflected light that reflects at the optical interface 42 defines an image that is then projected by the projection system 22 onto the screen 24. Regions of the image that are not to be illuminated are switched off by FTIR, which blocks the TIR. Light blocked by FTIR tends to propagate near the optical interface 42 as dumped light L_{D}. To avoid having the dumped light L_{D} inadvertently propagate back into the projection optical path, a light sink 46 is provided to absorb the dumped light L_{D}. The light sink 46 can be embodied in various ways, such as taking the form of a material with low optical emissivity or high absorption coefficient, or being embodied as a geometrical black body formed as a cavity of high absorption material that receives the dumped light L_{D}, or so forth.

The microelectromechanical system 40 is optionally mounted on a circuit board 50 which optionally also supports a controller 52 embodied in the embodiment illustrated in FIG. 1 by an integrated circuit package (shown in part in FIG. 1). The controller 52 is electrically interconnected with the microelectromechanical system 40 to control the latter to form the image. Optionally, the circuit board 50 further supports other electronics 54, such as television receiver electronics, electronics for reading an audiovideo disk or other storage medium, or so forth. Optionally, the circuit board 50 may include a metal core 56, such as a copper plate, to assist in dissipating or spreading heat generated by the mounted elements 40, 52, 54. Instead of being integrated on the common circuit board 50, some or all of the elements 40, 52, 54 may be disposed separately.

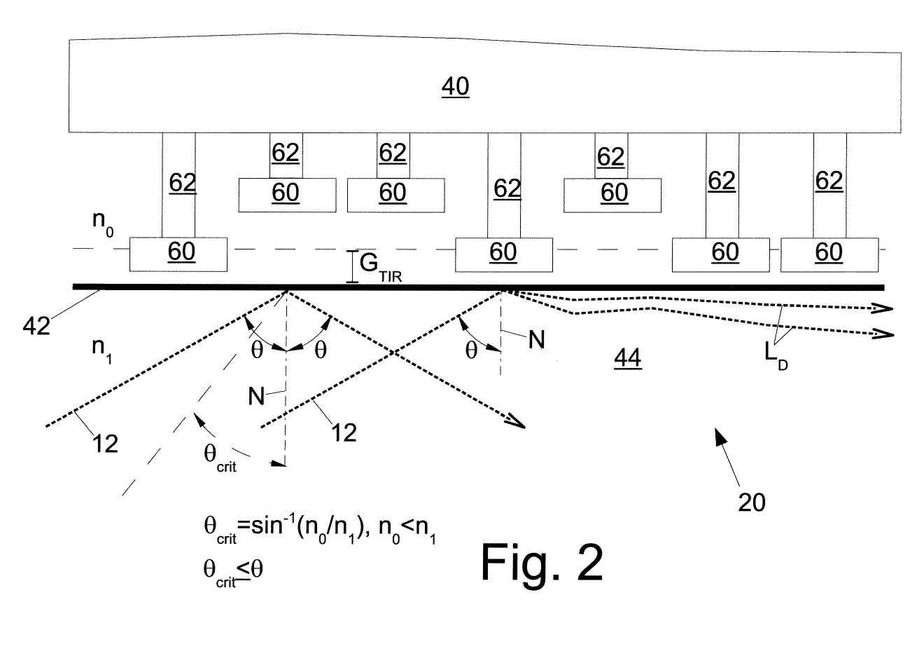

With continuing reference to FIG. 1 and with further reference to FIG. 2, operation of the image formation device 20 is further described. The illumination light 12 impinges upon the optical interface 42 at an angle of incidence θ measured off of an interface normal N of the optical interface 42, where the angle of incidence θ is equal to or larger than a critical angle θ_{c} for total internal reflection, i.e. θ≧θ_{c}. The critical angle θ_{c} is given by the expression θ_{c}=sin⁻¹(n₀/n₁), where n₁ is the refractive index of the bent tube optical element 44 (or, more generally, the n₁ is the refractive index on the side of the optical interface from which the light is incident), n₀ is the refractive index on the other side of the optical interface 42, and the condition n₀<n₁ holds. For example, if the bent tube optical element 44 is made of glass (n₁˜1.5) and the ambient is air (n₀˜1) then the critical angle θ_{c}=41.8°. The TIR process is shown by the left-hand ray of illumination 12, which reflects off of the optical interface 42 at the same angle θ as the angle of incidence θ. Advantageously, the physics of the TIR process ensure that the optical interface 42 exhibits substantially 100% reflectance under the TIR condition. In contrast, an aluminum or other metalized micromirror of a DMD generally has a reflectivity of less than 100%.

The microelectromechanical system 40 spatially modulates the TIR to define the image. The microelectromechanical system 40 is suitably manufactured of silicon, silicon carbide, or another material amenable for MEMS fabrication, and includes an array of movable elements 60 corresponding to pixels of the image. The movable elements 60 are movable by microelectromechanical actuators 62 so as to move each movable element 60 toward the optical interface 42 to locally frustrate total internal reflection at the optical interface 42, or away from the optical interface to not locally frustrate total internal reflection at the optical interface. The FTIR effect is based on the presence of an evanescent wave that penetrates beyond the optical interface 42 during TIR. In FIG. 2, the spatial extent of the evanescent wave is indicated diagrammatically by a TIR gap G_{TIR}. As seen in FIG. 2, when the movable element 60 is away from the optical interface 42 by substantially more than the TIR gap G_{TIR}, the TIR effect is not frustrated and TIR occurs. This is illustrated by the lefthand ray of illumination 12 diagrammatically shown in FIG. 2. As a result, those movable elements 60 that are moved away from the optical interface 42 do not interfere locally with the TIR, and so light is reflected to illuminate a corresponding pixel of the projected display image. The corresponding pixel is “on”, that is, lighted.

On the other hand, when the movable element 60 is moved substantially into the TIR gap G_{TIR}, the total internal reflection is frustrated—that is, FTIR occurs. This is diagrammatically illustrated by the righthand ray of illumination 12 shown in FIG. 2. The FTIR prevents reflection by TIR, and instead the incident light tends to travel close to the optical interface 42 as dump light L_{D}, or depending upon the optical characteristics of the movable element 60, the wavelength of light, the refractive indices n₀, n₁, and other factors may pass through the optical interface 42 to be absorbed by the proximate movable element 60 or be otherwise lost (not illustrated in FIG. 2). As a result, those movable elements 60 that are moved substantially into the TIR gap G_{TIR} act to locally frustrate the TIR, and so the light is dumped and does not illuminate the corresponding pixel of the projected display image. The corresponding pixel is “off”, that is, not lighted.

The distance over which the evanescent wave extends away from the optical interface 42 is dependent upon factors such as the refractive indices n₀ and n₁, the wavelength of light, and so forth. The size of the TIR gap G_{TIR} depends on the distance over which the evanescent wave extends away from the optical interface 42. The size of the TIR gap G_{TIR} also depends on the optical characteristics of the movable element 60, because it is the change in refractive index induced by the proximate movable element 60 in the region of the evanescent wave that causes the FTIR effect. Typically, movable elements with larger refractive indices tend to more effectively induce the FTIR effect. For illumination 12 in the visible range, n₁ of order 1.5-2.0, and movable elements with refractive indices greater than or about 1.5 (this latter condition being satisfied by most solid materials including for example silicon, silicon carbide, and silicon nitride), the TIR gap G_{TIR} is typically of order 10 microns. Moreover, while the TIR gap G_{TIR} is illustrated as a discrete gap, in reality the evanescent wave decays exponentially with increasing distance from the optical interface 42, and so the TIR gap G_{TIR} is not abruptly defined.

In some embodiments, the microelectromechanical system 40 including the movable elements 60 is made of silicon, and the movable elements 60 and associated microactuators 62 take the form of micropistons as shown in FIG. 2. In other embodiments, the movable elements may take other forms, such as microcantilever structures, or deformable structures that are compressed or expanded laterally to produce corresponding extension toward or retraction from the optical interface 42. In the latter embodiments, the movable structures deform like a squeezed or stretched balloon, and may or may not also exhibit translational or pivoting movement. To maximize the “fill factor” and provide high optical efficiency, the gaps between the movable elements 60 should be made as small as practicable. For example, the total area of the movable elements 60 should be substantially larger than the total area of the gaps between the movable elements 60. In some embodiments, movement of a movable element toward the optical interface 42 causes the movable element to contact and press against the optical interface 42. In such embodiments, it is contemplated for the contacting portion of the movable element to spread out laterally due to compressive contact to enhance the fill factor.

In general, substantially any MEMS fabrication method is suitable for manufacturing the microelectromechanical system 40. Advantageously, the existing mature MEMS fabrication technology used for manufacturing DMD image formation devices such as are used in DLP projection displays is readily adapted to the manufacture of the microelectromechanical system 40.

However, the image formation device 20 has substantial advantages over existing MEMS-based DLP projection display devices that employ DMD image formation devices. In DMD, the reflective micromirrors are moved between “on” and “off” positions, and in the “on” position the micromirror reflects light into the corresponding pixel of the projected image. Accordingly, the micromirror angle must be precisely set in the “on” position in order to precisely reflect light into the corresponding pixel of the projected image. This is typically achieved in DMD by having the micromirror contact a landing.

In contrast, the movable elements 60 do not control the angle of reflected light in the “on” position. Rather, the “on” position corresponds to the movable element 60 being moved away from the optical interface 42 by an amount greater than the TIR gap G_{TIR}. The angle of reflection in this case is determined solely by the optical interface 42, which is a stationary nonmoving interface that can be precisely formed using conventional optical fabrication methods. Further, the angle of reflection across the array can be made highly uniform simply by making the optical interface 42 precisely planar. This is readily accomplished using conventional precision optical element fabrication techniques. Even in the “off” position, precise positioning of the movable elements 60 is not called for. Rather, to turn a pixel “off” it is sufficient for the movable element 60 to penetrate substantially into the TIR gap G_{TIR}—tolerances for this “off” positioning are of order one micron or larger.

In operation, the controller 52 suitably uses a digital control to set the grayscale intensity. This process is closely analogous to the grayscale intensity control used in DMD. Each movable element 60 is movable between a first (e.g., “off”) position at which the movable element 60 locally frustrates total internal reflection at the optical interface 42 and a second (e.g., “on”) position at which the movable element 60 does not locally frustrate total internal reflection at the optical interface 42. Each movable element 60 is moved cyclically toward the optical interface 42 so as to penetrate substantially into the TIR gap G_{TIR} (i.e., into the first or “off” position) and away from the optical interface 42 so as to withdraw from the TIR gap G_{TIR} (i.e., into the second or “on” position). The grayscale level is controlled by the controller 52 by adjusting a characteristic of the cyclical movement of each movable element 60 to control the grayscale level of the corresponding image pixel. For example, a duty cycle of the cyclical movement may be adjusted to control the grayscale level of the corresponding image pixel.

It is also contemplated to configure the controller 52 to adjust the gap between the movable element 60 and the optical interface 42 to adjust the amount of local frustration of total internal reflection at the optical interface 42 so as to set the grayscale level of the corresponding image pixel. This analog approach to grayscale intensity control is possible because of the gradual decay of the evanescent wave with increasing distance away from the optical interface 42.

Yet another advantage of the image formation device 20 over existing MEMS-based projection technologies employing DMD is that the movable elements 60 in some embodiments are arranged to move freely between the first or “off” position and the second or “on” position without contacting a landing in either the “off” or “on” positions. As a result, in these embodiments the “sticking” failure mode sometimes encountered in DMD, in which a micromirror adheres or coheres to a landing and resists breaking contact with the landing, is wholly avoided. Alternatively, landings can be provided in one or both of the first and second positions. In some embodiments the optical interface 42 serves as a landing for the first or “off” position, such that the movable element contacts the optical interface 42 to provide FTIR. The adhesion forces between some optical interface materials such as glass and some MEMS materials such as silicon is relatively small, thus reducing a likelihood of sticking failure.

Still yet another advantage of the image formation device 20 over existing MEMS-based projection technologies employing DMD is higher operating speed. DMD operating speed is limited by the need to precisely position the micromirrors in the “on” positions in order to light corresponding pixels, and potentially by latency introduced by adhesive or cohesive forces between the micromirrors and the associated landings. In contrast, the image formation device 20 can operate with substantially higher tolerances enabling tradeoff between speed and spatial tolerance, and additionally landing contact induced latencies are avoided in embodiments in which the movable elements 60 are arranged to move freely without contacting landings in either the “on” or “off” positions.

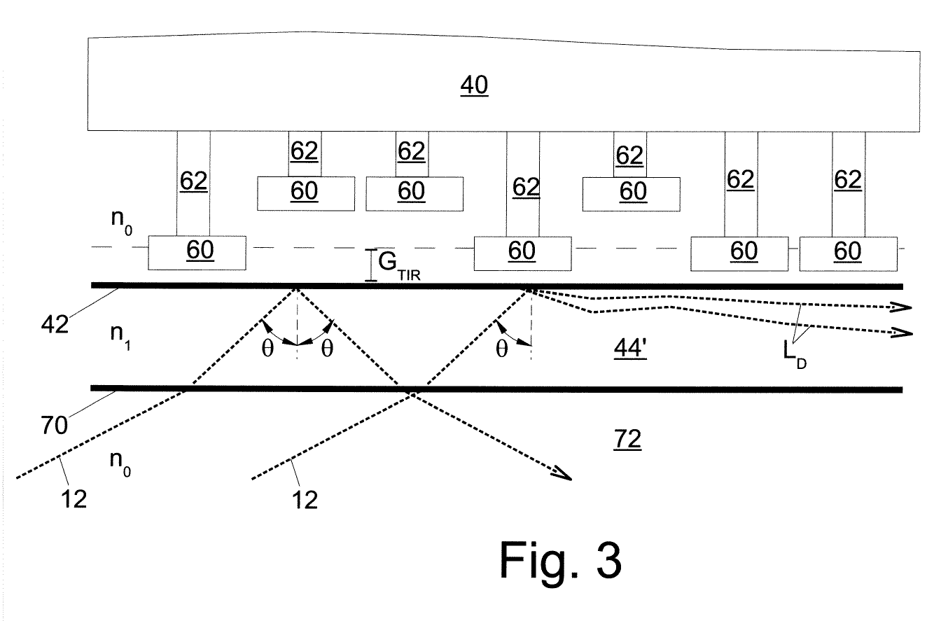

With reference to FIG. 3, another FTIR MEMS-based image formation device 20′ suitable for use in a projection display is described. The device 20′ uses the same microelectromechanical system 40 as the device 20, including the movable elements 60 operated by actuators 62, and also includes the optical interface 42. However, in the image formation device 20′ of FIG. 3 the bent tube optical element 44 is replaced by a planar optical element 44′ that is bounded by the aforementioned optical interface 42 and also by a second, parallel planar optical interface 70 beyond which an air ambient 72 exists. The illumination 12 is applied to the image formation device 20′ from the air ambient 72 onto the optical interface 70. No TIR occurs at the optical interface 70 because the light is incident from the side of the interface 70 having lower refractive index. The illumination passes through the planar optical element 72 to impinge upon the optical interface 42 where spatial modulation by the microelectromechanical system 40 is performed as already described respective to the image formation device 20 to effectuate image formation.

The projection display device of FIG. 1 employs a single image formation device. To obtain a full color display, the illustrated filter wheel 26, cycling operation of LEDs of different primary colors, or another mechanism for temporally cycling between primary colors, and further components 30, 32 for synchronizing the image formation process with the primary color cycling, is provided. Using this single-image formation device arrangement, different primary color images (optionally including white) can be generated in rapid temporal succession such that the human eye perceives the successive images as a single blended full color image. On the other hand, if a black-and-white projection display device is desired, then the device of FIG. 1 is suitable with the filter wheel 26 and associated components 30, 32 omitted.

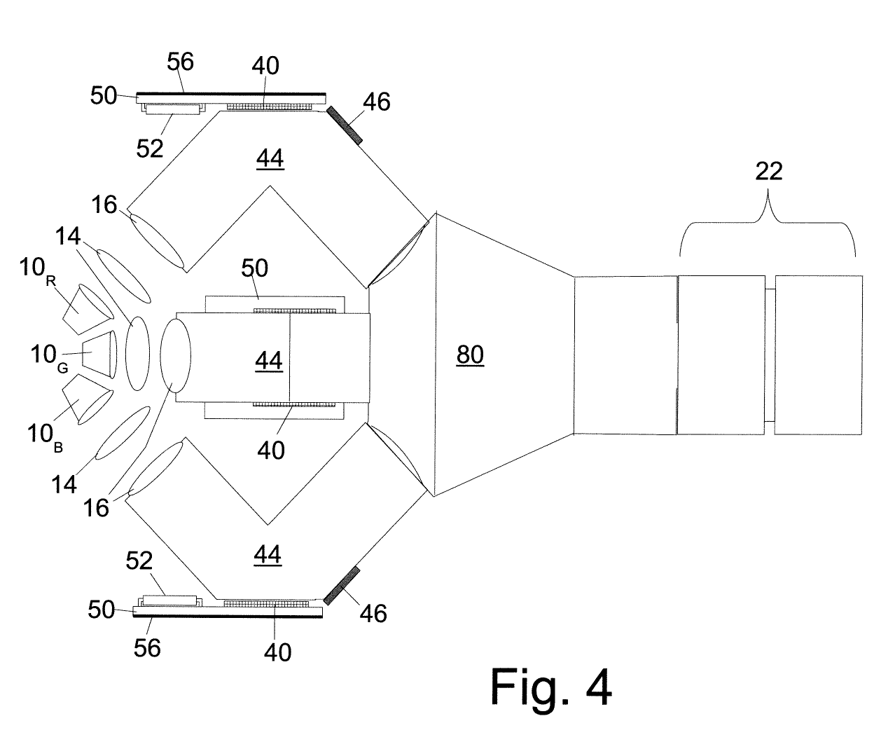

With reference to FIG. 4, another full color projection display device is illustrated, which uses three image formation devices. Separate red, green, and blue light sources 10_{R}, 10_{G}, 10_{B} provide respective red, green, and blue illumination light input to the three image formation devices. Each image formation device includes the bent tube optical element 44 made of a light transmissive material defining the optical interface 42 and image modulating microelectromechanical system 40 with associated controller 52 (the controller is blocked from view in the case of the green channel shown in FIG. 4). The three light sources 10_{R}, 10_{G}, 10_{B} and associated image formation devices generate respective red, green, and blue light beams with red, green, and blue images defined simultaneously by the three image formation devices. These images are input to an optical combiner element 80 which includes suitable refractive, waveguiding, reflective, or other optical elements so as to combine the red, green, and blue beams to form a combined beam with a defined full color image comprising the combined red, green, and blue images. The projection system 22 then projects the full color image onto a suitable transmissive or reflective screen (not shown in FIG. 4) as in the projection display device of FIG. 1.

The skilled artisan will recognize that the full color projection device of FIG. 4 is closely analogous to existing “three-chip” DLP projection devices that employ separate red, green, and blue light sources modulated by three separate DMD image formation devices. Indeed, the optical combiner element 80 is suitably identical to the optical combiner elements used in such three-chip DLP projection devices.

In the illustrated embodiments, the projection system 22 projects light from the light source that undergoes total internal reflection at the optical interface 42. Light which is frustrated by the movable elements 60 is dumped light L_{D} that is discarded and not projected.

However, it is also contemplated to project the light from the light source that is frustrated by the movable elements from undergoing total internal reflection at the optical interface, and to discard the light that undergoes TIR. This latter approach is generally not preferred because it does not attain the advantage that the projected light is reflected from the optical interface 42 which can be precisely constructed. Moreover, the light that is frustrated by the movable elements from undergoing total internal reflection at the optical interface is more likely to have intensity variation due to the precise positioning of the movable elements. Nonetheless, in some embodiments it may be advantageous to project the light from the light source that is frustrated by the movable elements from undergoing total internal reflection. For example, if the microelectromechanical system is optically transparent, it may be possible to have the light from the light source that is frustrated by the movable elements from undergoing total internal reflection pass through the microelectromechanical system, so that the projected light is not reflected at all.

Still further, while projection display devices have been illustrated herein as examples, it is also contemplated to use the image forming device 20, 20′ for other applications, such as for direct viewing applications. Moreover, the term “projection system” as used herein is intended to be broadly construed to encompass any system which processes the image beam to form a viewable image. In a contemplated cellular telephone application, for example, illumination reflected by TIR at the optical interface and spatially modulated by the microelectromechanical system using FTIR is suitably input to a prism that reflects the TIR beam onto a light transmissive screen. In these embodiments, the prism may or may not provide image magnification—in some such embodiments the prism merely redirects the beam onto the light transmissive screen without magnification.

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

1. A projection display device comprising:
an optical interface;
a microelectromechanical system including an array of movable elements corresponding to image pixels, each movable element being movable toward the optical interface to locally frustrate total internal reflection at the optical interface and movable away from the optical interface to not locally frustrate total internal reflection at the optical interface;
a light source arranged to illuminate the optical interface at an angle effective for producing total internal reflection at the optical interface; and
an optical projector system arranged to project one but not both of:
light from the light source that undergoes total internal reflection at the optical interface, and
light from the light source that is frustrated by the movable elements from undergoing total internal reflection at the optical interface.

2. The projection display device as set forth in claim 1, further comprising:
a screen, the optical projector system arranged to project onto the screen to form a display reflected by or transmitted through the screen formed of image pixels having intensity values controlled by corresponding movable elements of the microelectromechanical system.

3. The projection display device as set forth in claim 1, wherein the optical projector system is arranged to project light from the light source that undergoes total internal reflection at the optical interface.

4. The projection display device as set forth in claim 1, wherein the optical interface comprises:
a planar interface between a light transmissive solid and air, the light transmissive solid having a refractive index greater than unity, the light source arranged to illuminate the optical interface from the light transmissive solid side.

5. The projection display device as set forth in claim 1, wherein each movable element is movable between a first position at which the movable element locally frustrates total internal reflection at the optical interface and a second position at which the movable element does not locally frustrate total internal reflection at the optical interface.

6. The projection display device as set forth in claim 5, wherein the movable elements do not contact a landing surface in either the first or second positions.

7. The projection display device as set forth in claim 5, wherein the movable elements comprise micropistons.

8. The projection display device as set forth in claim 5, wherein the movable elements are selected from a group consisting of micropistons and microcantilevers.

9. The projection display device as set forth in claim 1, further comprising:
a controller configured to control the microelectromechanical system to move each movable element toward the optical interface to locally frustrate total internal reflection at the optical interface or away from the optical interface to not locally frustrate total internal reflection at the optical interface so as to control a grayscale level of the corresponding image pixel.

10. The projection display device as set forth in claim 9, wherein the controller is configured to cyclically move each movable element toward the optical interface to locally frustrate total internal reflection at the optical interface and away from the optical interface to not locally frustrate total internal reflection at the optical interface, the controller being configured to control a characteristic of the cyclical movement of each movable element to control the grayscale level of the corresponding image pixel.

11. The projection display device as set forth in claim 10, wherein the controller is configured to control a duty cycle of the cyclical movement to control the grayscale level of the corresponding image pixel.

12. The projection display device as set forth in claim 9, wherein the controller is configured to adjust a gap between the movable element and the optical interface to adjust an amount of local frustration of total internal reflection at the optical interface so as to set the grayscale level of the corresponding image pixel.

13. The projection display device as set forth in claim 1, wherein the light source is arranged to cyclically illuminate the optical interface with light of a plurality of different colors selected to be combinable to generate a white display, and the projection display device further comprises:
a controller configured to control the microelectromechanical system to operate the array of movable elements in coordination with the cyclical illumination to cyclically define images of the different colors.

14. The projection display device as set forth in claim 1, wherein:
the optical interface comprises a plurality of optical interfaces;
the microelectromechanical system comprises a plurality of independently operable microelectromechanical systems corresponding to the plurality of optical interfaces, each microelectromechanical system including an array of movable elements each movable toward the corresponding optical interface to locally frustrate total internal reflection at the corresponding optical interface; and
the light source is arranged to illuminate each optical interface with light of a different color.

15. The projection display device as set forth in claim 1, wherein the projection display device comprises a projection television.

16. An image formation device comprising:
an optical interface; and
a microelectromechanical system including an array of movable elements corresponding to image pixels, each movable element being movable toward the optical interface to locally frustrate total internal reflection at the optical interface and movable away from the optical interface to not locally frustrate total internal reflection at the optical interface.

17. The image formation device as set forth in claim 16, further comprising:
a controller configured to cyclically move each movable element toward the optical interface to locally frustrate total internal reflection at the optical interface and away from the optical interface to not locally frustrate total internal reflection at the optical interface, the controller being configured to control a characteristic of the cyclical movement of each movable element to control a grayscale level of the corresponding image pixel.

18. An apparatus comprising:
an optical interface arranged to reflect a beam of light by total internal reflection; and
a microelectromechanical system configured to spatially modulate the total internal reflection across the optical interface such that the beam reflected by total internal reflection defines an image.

19. The apparatus as set forth in claim 18, further comprising:
an optical projector system arranged to project the reflected beam to form a projected image.

20. The apparatus as set forth in claim 19, further comprising:
a light transmissive projection television screen optically coupled with the optical projector system to display the projected image.

21. The apparatus as set forth in claim 19, further comprising:
a screen optically coupled with the optical projector system to reflectively display the projected image.

22. The apparatus as set forth in claim 18, wherein the microelectromechanical system is configured to selectively locally frustrate the total internal reflection at the optical interface to define the image.

23. The apparatus as set forth in claim 18, wherein the microelectromechanical system is comprises:
an array of movable elements; and
microactuators configured to move the movable elements toward or away from the optical interface to selectively locally frustrate total internal reflection at the optical interface to define the image.

24. A projection display device comprising:
an image forming device including an optical interface and an array of movable elements selectively movable toward or away from the optical interface to selectively locally frustrate total internal reflection at the optical interface such that light totally internally reflected at the optical interface defines an image; and
an optical projector system including the image forming device.

25. The projection display device as set forth in claim 24, wherein the projection display device is selected from a group consisting of a rear projection television, a front projection television, a theatre projector, and an overhead projector.
